(19) United States
(12) Patent Application Publication
(10) Pub. No.: US 2015/0242574 A1
(43) Pub. Date: Aug. 27, 2015

(54) NETWORK-BASED SYSTEMS AND METHODS FOR EFFICIENT FILTERING AND ROUTING OF HEALTHCARE INFORMATION

(71) Applicants: Sandeep Antony, Columbia, MD (US); Scott Afzal, Washington, DC (US); David Horrocks, Baltimore, MD (US); Yedong Tang, Columbia, MD (US)

(72) Inventors: Sandeep Antony, Columbia, MD (US); Scott Afzal, Washington, DC (US); David Horrocks, Baltimore, MD (US); Yedong Tang, Columbia, MD (US)

(21) Appl. No.: 14/189,225

(22) Filed: Feb. 25, 2014

(51) Int. Cl. G06F 19/00

(52) U.S. Cl. CPC G06F 19/324

(57) ABSTRACT

Networks and methods include or use a computer hardware processor to manage healthcare information between healthcare sources and providing subscribers. Subscriber requests and healthcare information about patients are used in the networks and methods to provide only responsive content to subscribers. Networks and methods screen healthcare with criteria in the subscriber requests, and only when the information matches the criteria, provides a deliverable based on the healthcare information, in desired format and fashion, to the subscriber associated with the matching criteria. Systems and methods perform one or multiple different types of comparisons between received provider actions and subscribing provider requests, including targeted screenings that initially filter out non-responsive information and call out a particular subscriber's parameters to be used in handling the data, as well as comprehensive associations that look at all related healthcare information vis-à-vis any subscriber's time, manner, condition, format requirements for notifying the subscriber that the information.

### BACKGROUND

Healthcare information, including patient medical records and activities, facility encounters, insurance information, provider institutions, billing data, government healthcare support information, etc., across a large population can be aggregated in a Health Information Exchange (HIE) or similar database. For example, providers, insurers, and/or or governmental bodies may gather relevant healthcare information for all patients, providers, insurers, and other healthcare actors in exchanges. An example of a related art HIE may be Maryland's CRISP network and associated Master Patient Index (MPI). FIG. 1 is an illustration of a related health information exchange system 10. As shown in FIG. 1, system 10 includes a HIE 15 having a healthcare information routing and demographic matching structure 30, healthcare information database 21, and a healthcare information logic structure 20.

Healthcare information routing and demographics matching structure 30 may be a digitized or computer-based system that facilitates entry, gathering, and organization of healthcare information from one or more providers 50. For example, providers 50 may be emergency rooms, outpatient clinics, urgent care offices, pharmacies, laboratories, assisted living facilities, visiting nurse networks, etc. Providers 50 typically provide a variety of healthcare information to HIE 15 via healthcare information routing and demographics matching structure 30. For example, a provider 50 may provide clinical feeds 36, patient Admit-Discharge-Transfer (ADT) messages 35, and/or any other healthcare information to healthcare information routing and demographics matching structure 30. The healthcare information, including content from clinical feeds 36 and ADT messages 35, may include many different types of relevant healthcare information, including patient biographical information, treatment, other medical history, insurance information, provider activities, lab results, charges for services, etc. that typically reflect healthcare information on a per patient basis. Particularly, ADT messages 35 may be generated and transmitted any time a patient has an encounter with a hospital 50, such as an admittance, discharge, transfer, to/from/within a hospital, and ADT messages 35 include this encounter information.

As shown in FIG. 1, healthcare information routing and demographics matching structure 30 may include an interface or router 32 that receives clinical feeds 36 and/or ADT messages 35 from hospitals 50. The router 32 may process or otherwise prepare data for entry into a database 21 and associated master patient index 31, which matches patient identifying information with content of database 21 to reconcile patient identity within health information exchange 15.

Subscribing participants 60 may access healthcare information stored in database 21 as indexed by master patient index 31 through healthcare information logic structure 20 in health information exchange 15 that is interfaced with healthcare information routing and demographics matching structure 30. Subscribing participants 60 may be, for example, physicians needing comprehensive healthcare information regarding patients who present at urgent care.

Two mechanisms may be provided in system 10 to provide information to subscribing participants 60. In one instance, subscribing participants 60 can login or otherwise access healthcare information logic structure 20 through a query portal 25. Subscribing participants 60 can enter queries 26 into portal 25, which is interfaced with healthcare information logic structure 20. Logic structure 20 may properly gather and/or associate data from database 21 with master patient index 31 based on the parameters of query 26 and any access/information rules applicable to system 10. In another instance, subscribing participants 60 may be delivered direct notifications 27, such as via email or alert every time an ADT message 35 or other healthcare update occurs to a patient.

### SUMMARY

Example methods and embodiments manage healthcare information in computer-based networks between healthcare sources and subscribers. Example methods can include transmitting subscriber requests to a healthcare notification system with a computer processor and associated transient memory and possibly persistent memory as well. The subscriber requests can include several different criteria for how and what notifications should be provided to subscribers by the system. In example methods, healthcare information about patients are also transmitted to the system from a source, like a health information exchange or healthcare database. With the requests and information, the system can perform a variety of functions that result in only responsive content provided to subscribers. For example, the system may filter the information against criteria in the subscriber requests, like patient biographical information, encounter types, or provider identity. Only when the information matches the criteria may it be provided, in desired format and fashion, to the subscriber who submitted the criteria. In doing so, the system can perform multiple instances and levels of screening healthcare information to ensure that only matched information is forwarded while also ensuring that matches can be achieved based on several different criteria and information available in the network. For example, received healthcare information may be initially compared against a table of notification conditions each correlated with a single subscriber to determine if anything at all should be done with the information and/or whether only a sub-population of subscribers and their information needs to be consulted in any further methods. As a different thorough screening, the received healthcare information, along with corrections and enhancements available may be matched against in any aspect against the entire population of subscriber requests.

Example methods are useable in a variety of healthcare information settings and can work with multiple HIEs or other third-party databases providing information from clinical feeds, through ADT messages, over the Internet, etc. Example methods can also benefit a variety of different subscribers, including healthcare providers like primary care physicians, emergency rooms, specialists, physical therapists, home healthcare specialists, insurance providers, governmental agencies, and/or healthcare organizations.

Example networks include a computer processor and are communicatively connected to, and potentially control, subscribers and healthcare information sources. Example networks can include logic, intake, and notification modules that perform these name functions or execute example methods. For example, a network may acquire healthcare information based on actions with the patients at treatment facilities or encounters with healthcare providers, including things like ADT messages with admissions, transfers, discharges, and billing status changes. Because the alerts may be presented in massive amount and with varying quality of information, an example network may scrutinize the alerts against provided subscriber information to ensure that only and all responsive alerts are identified. An example network may then offer the filtered and comprehensive alerts to the properly-corresponding subscribers in any format, frequency, and manner desired. Example networks can also perform multiple types and levels of filtering in combination with other processing methods.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of a related art health information exchange system.

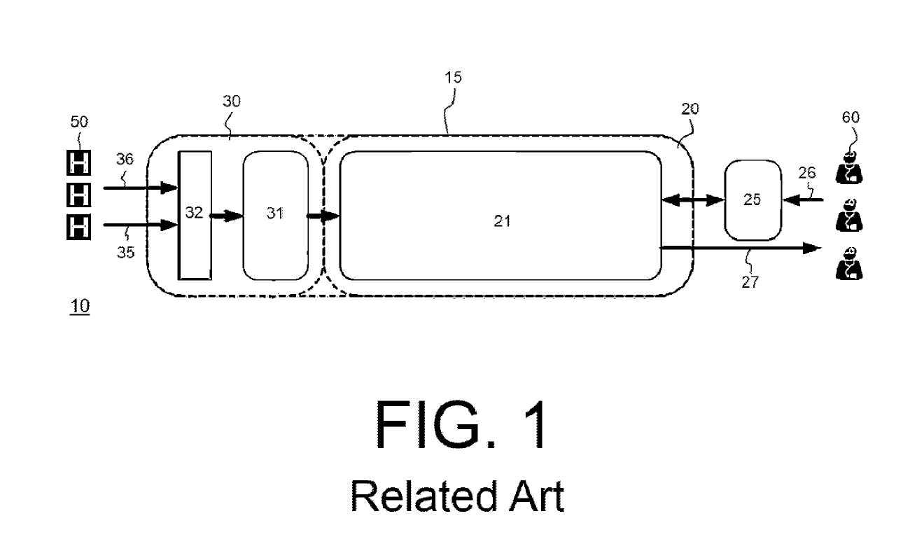

FIG. 2 is an illustration of an example embodiment healthcare notification system.

FIG. 3 is an illustration of another example embodiment healthcare notification system.

FIG. 4 is a flowchart of example method(s) of providing filtered healthcare notifications to subscribers.

### DETAILED DESCRIPTION

This is a patent document, and general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when element(s) are referred to in relation to one another, such as being “connected,” “coupled,” “mated,” “attached,” or “fixed” to another element(s), the relationship can be direct or with other intervening elements. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “connected” for communications purposes includes all variations of information exchange routes between two devices, including intermediary devices, networks, etc., connected wirelessly or not.

As used herein, the singular forms “a”, “an,” and “the” are intended to include both the singular and plural forms, unless the language explicitly indicates otherwise with terms like “only a single element.” It will be further understood that the terms “comprises,” “comprising,” “includes,” and/or “including,” when used herein, specify the presence of stated features, values, steps, operations, elements, and/or components, but do not themselves preclude the presence or addition of one or more other features, values, steps, operations, elements, components, and/or groups thereof.

It should also be noted that the structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations. It should be presumed that any embodiment having features and functionality described below, in any workable combination, falls within the scope of example embodiments.

The following co-owned applications are incorporated by reference herein in their entireties: U.S. application Ser. No. 13/844,332 to Antony et al. filed Mar. 15, 2013 (Docket No. 3.0001.1); U.S. application Ser. No. 14/142,625 to Antony et al. filed Dec. 27, 2013 (Docket No. 3.0001.2); U.S. application Ser. No. 14/______ to Antony et al. filed Feb. 25, 2014 (Docket No. 3.0003.1); and U.S. application Ser. No. 14/______ to Antony et al. filed Feb. 25, 2014 (Docket No. 3.0004.1). Moreover, the example methods and embodiments of the incorporated documents are useable in whole and in part in addition to, or in replacement of, example systems and methods, including individual components, elements, structures, steps, connections, actions, data structures, functionalities, etc. thereof.

The inventors have recognized that existing healthcare notification systems do not have a method for flexibly and consistently alerting relevant healthcare stakeholders, such as providers and payers, when patients, members, and/or citizen populations receive healthcare or engage in healthcare-related activities meeting specific stakeholder interests. Related systems may use information contained within an ADT message itself to route an alert to the appropriate recipient; however, ADT data often lacks all relevant associated patient information available in other information stores, and/or contains errors because it is commonly recorded by hand and relies on the information a patient relays at registration, sometimes under duress at an emergency room. Worse, related systems may pass all ADT messages directly to providers identified therein, resulting in overwhelming volume and irrelevancy of information provided. This may cause recipients to become fatigued by constant and/or low-value messaging, resulting in less useful information for care management realized by existing systems.

The inventors have further recognized that other, more accurate sources of patient and healthcare information may be possessed by healthcare providers, insurers, governments, and other bodies not immediately performing healthcare services. This more accurate information can be solicited from providers as a means for filter messaging and also improve message content. Related art systems may not fully take advantage of the synergy between different healthcare information sources and providers to so enhance information delivery. Moreover, related art systems may not be sufficiently configured with filters to deliver enhanced, high-quality information that is responsive only to several different subscriber requests, while minimizing resource consumption in delivery networks. The below disclosure uniquely overcomes these and other problems recognized by the inventors in healthcare information networks.

The present invention is computer networks, software, and/or hardware that receive healthcare information and subscriber information and selectively provide notifications to subscribers based on these information and/or methods of doing the same. In contrast to the present invention, the few example embodiments and example methods discussed below illustrate just a subset of the variety of different configurations that can be used as and/or in connection with the present invention.

### Example Embodiments

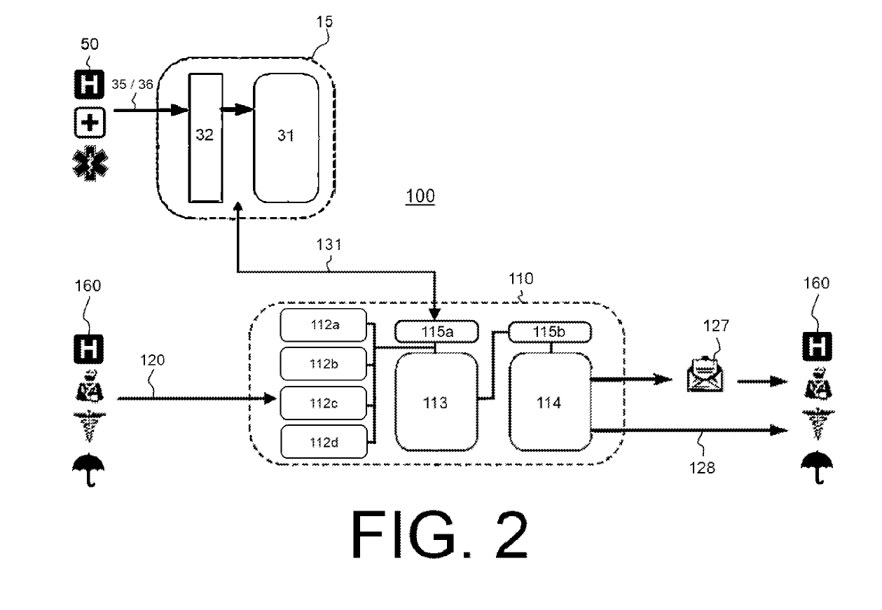

FIG. 2 is a diagram of an example embodiment healthcare notification system 100 that can be physically and logically configured through proper hardware infrastructure and/or software programming to provide targeted healthcare notifications and/or execute example methods of providing healthcare information. As shown in FIG. 2, example embodiment healthcare notification cluster 110 may be connected to a source of healthcare information, like a health information exchange (HIE) 15 in example embodiment system 100. Healthcare notification cluster 110 and HIE 15 may be co-located or remote, and may be connected via a dedicated connection or bus in a same setting or over great distances through networks such as VPNs, WANs, LANs, or the Internet.

Although example embodiment healthcare notification system 100 includes HIE 15 as a healthcare information source, it is understood that other types of sources for healthcare information are useable with example embodiments and methods. For example, a healthcare provider network system or other database having different data and interface configuration may be used in place of HIE 15. Still further, HIE 15 could be fully contained within healthcare notification cluster 110 to provide a centralized system for receiving, storing, processing, and/or delivering desired healthcare information to various subscribing providers 160. HIE 15 may equally be remote and operated by a distinct actor, such as a state-operated database.

As shown in FIG. 2, healthcare notification cluster 110 is configured to receive subscriber information including subscriber parameters 120 from subscribing providers 160. Example embodiment healthcare notification system 100 is useable with a wide variety of subscribing providers 160, including primary care physicians, specialists, insurance providers, hospitals, labs, clinics, home healthcare providers, government entities etc. who may want or may be able to provide unique services with specific types of healthcare information, in specific formats, in specific circumstances.

Subscriber parameters 120 define at least some services and/or actions to be provided by example embodiment system 100. For example, subscriber parameters 120 may include a roster of patient information—including hospital identifier, member ID, any names, home address, city, state, zip code, date of birth, gender, ssn, phone numbers, membership status, etc. and/or portions thereof—identifying patients relevant to subscribers 160. For example, patient information submitted in parameters 120 may be associated with patients under the care of, covered by, and/or under the jurisdiction of subscribing providers 160. Other subscriber information may also be transmitted separately and/or as a part of subscriber parameters 120, including subscriber name, type, service level, enterprise or tax identification numbers, etc.

Subscriber parameters 120 may be input and/or updated into healthcare notification cluster 110 through a subscriber login interface, manually from subscriber parameters 120 that are delivered, such as from a spreadsheet via email, and/or automatically generated in cluster 110 based on a ruleset. For example, each subscribing provider 160 may provide subscriber parameters 120 to healthcare notification cluster 110 through any type of communication possible within a computer-processor-based network, including email, direct connection, manual input, etc. Subscribing providers 160 may provide multiple subscriber parameters 120 at signup and/or modify existing subscriber parameters 120, as their patients and needs and desires for healthcare information change.

Healthcare notification cluster 110 may include an input structure 112 to receive, process, and update/store information from subscriber parameters 120 in accordance with a transmission method used in example embodiment cluster 110. Input structure 112 may be, for example, a module or subroutine within healthcare notification cluster 110 or may be a dedicated server with independent processing capability, depending on the configuration of healthcare notification cluster 110. Alternatively, no separate input structure may be used, instead, a common processor and database may execute all functionality of input structures 112 along with all other functionality of healthcare notification cluster 110.

In example embodiment healthcare notification cluster 110 of FIG. 2, several input structures 112a-d are used, each with storage capability. Input structures 112a-d may be panels individualized to each subscriber 160; that is, each subscriber 160 may have a one-to-one assigned input structure 112x that stores subscription information, including subscriber parameters 120, only for the one assigned subscriber. In this way, an individual subscriber panel 112x can be created and/or updated for each subscriber 160, allowing for modular handling of subscriber information and interaction between subscribers 160 and cluster 110. It is understood that subscriber panels 112a-d may still share a common database or physical storage location, such as with separately-assigned memories, and/or may use different associations between numbers and types of subscribers 160 and input structures 112, aside from the one-to-one association between four subscribers 160 and four panels 112a-d shown in FIG. 2.

Subscriber parameters 120 stored by input structure 112 may include any kind of subscription information. As discussed above, subscriber parameters 120 may set out a roster of responsive client identification and/or a variety of circumstances for which subscribing providers 160 desire healthcare information, including any combination of events or message types based on which to create notifications, frequency of notifications, delivery format, type preferences, etc. For example, parameters 120 may include a limiting set of events or circumstances for which subscribing providers 160 desire healthcare information. Further, subscriber parameters 120 may include healthcare information formatting, delivery options, analysis, and/or enhancement selections. For example, subscriber parameters 120 may provide auto-subscription information to be used in the example method of FIG. 5, or may request additional analysis or methods to be performed by cluster 110.

As further specific examples, a subscribing provider 160 who is a specialist may want only healthcare information relating to patients under the care of the specialist who have an admit-type ADT message 35 created for a condition within the specialist's field of practice; or a subscribing provider 160 who is a large general practice of physicians may want cumulative healthcare information provided only once a month for a particular subset of very active patients; or an insurance provider as a subscribing provider 160 may want to be notified only when a certain type of encounter that reflects a need for patient contact or intervention occurs, such as multiple ER visits for a condition that may be successfully treated in an outpatient setting. All these limiting factors are examples of filters that may be present in subscriber parameters 120.

Alternatively or additionally, subscriber parameters 120 may be automatically generated based on rules of example embodiment system 100, such as for policy compliance or service reasons. For example, a default set of subscriber parameters 120 may be provided for subscribing providers 160 who provide incomplete or incorrect parameters. Or, for example, if a subscribing provider 160 is a hospital, subscriber parameters 120 may be automatically generated for the hospital to include all patients discharged within the past 60 days, either as a desired service or to comply with regulation. Such automatic generation may be performed by example embodiment cluster 110, such as by input structure 112, for example, by analyzing subscriber information, including subscriber parameters 120, for input reflecting a type of subscriber, comparing such input against a stored list of desired parameters based on type of subscriber, and updating/storing subscriber parameters 120 with the additional parameters.

Example embodiment healthcare notification cluster 110 is interfaced with a healthcare information source. For example, cluster 110 may include an HIE interface 131 that is configured to communicate with healthcare information sources, such as MPI 31, HIE interface 32, and/or entire HIE 15. Thus, cluster 110, via logic core 113 and/or a separate interface, may recognize and understand how to retrieve and read specific data structures or information association regimes present within MPI 31, such as client IDs, patient-identifying information, relationships among entries and records, etc., stored in MPI 31. Cluster 110 may further receive and process treatment and/or encounter information from providers 50 transmitted via feeds 36, including ADT messages 35.

As seen in FIG. 2, example embodiment system 100 may require only directed front-end interfaces with a healthcare source, like an external or third-party HIE 15, reducing complexity and/or potential for connection error problems that might exist were all other portions of exchange 15 having their own connection to healthcare notification cluster 110 or if a subscriber had to directly deal with and query exchange 15. Logic core 113, HIE interface 131, and/or any other communications interface configured to communicate with the healthcare information source(s) may be a central routine, specifically-configured processor, and or wholly individual server with storage and processor within healthcare notification cluster 110, for example, depending on the configuration of healthcare notification cluster 110.

Healthcare notification cluster 110 may include one or more filters 115. For example, as shown in FIG. 2, cluster 110 includes a targeted panel filter 115a and a comprehensive filter 115b both interfacing with logic core 113. Like other functionalities of cluster 110, filter 115 may be separate machines networked in cluster 110 or can be hardware modules for software routines in logic core 113 programmed to perform their function(s) as described herein.

Example embodiment notification cluster 110 may include a targeted panel filter 115a. Targeted panel filter 115a may store several simple associations between healthcare information and specific input structures 112x, arranged in panel form to correspond to specific subscribers 160. For example, targeted panel filter 115a may store a simple list of patients identified in subscriber parameters 120 against a list of the specific subscriber or panel 112x associated with the specific subscriber submitting the parameter matching that patient. This could be a list of full patient names versus provider name, a portion of patients' birthday and SSN versus provider enterprise ID, a list of patient addresses or billing ID versus specific provider panel 112x, etc. Other relatively simple lists, such as conditions or treatment facilities versus subscribers, are also useable with targeted panel filter 115a.

Targeted panel filter 115a may generate a list of simple associations itself or be provided the same. For example, such a list may be created through monitoring or intercepting subscriber parameters 120 in/sent to cluster 110 and building a list from single pieces of information extracted therefrom, and/or logic engine 113 may create the list of simple associations at given intervals by mining input structures 112, for example. Still further, an operator or subscriber may input a simplified list for targeted panel filter 115a manually via a portal like a web or mobile interface. Targeted panel filter 115a may include a persistent memory for storing data, including such lists, over relatively long periods of time and operation.

Targeted panel filter 115a may directly receive information from HIE 15 and/or may process healthcare information otherwise received in cluster 110. In this way, targeted panel filter 115a may compare healthcare information against a simple list of information and providers, and handle healthcare information based on the same. For example, targeted panel filter 115a may monitor an ADT message 35 from a hospital 50 coming into cluster 110 and compare relevant information in ADT message 35—for example, patient address—against subscriber information in a stored list of simple associations. If there is a match—for example, the simple list includes the patient address associated with two subscriber panels 112a and 112c respectively for two different providers 160—targeted panel filter 115a may pass the ADT message along for use with other example methods.

Additionally, targeted panel filter 115a may cause only the parameters 120 for the matched subscriber 160 to be used in further methods and operations of cluster 110. For example, if filter 115a determines that only input structures 112a and 112c are listed against the address information in the ADT message, then only 112a and 112c may be used to enhance or correct the ADT message, and/or then only notification formatting or timing requirements in 112a and 112c may be used in generating a notification based on the ADT message. Use of only a matching panel from an initial list may avoid comprehensive querying of all subscriber information 120 stored across all input structures 112 and/or core 110. Further, because targeted panel filter 115a can immediately work on information sent from a provider 50 in a targeted fashion, example embodiment cluster 110 may not have to wait for processing/enhancement in HIE 15 and/or full comparisons with all input structure 112 to know whether and how a piece of information will be acted on through parameters 120 in a single subscriber's panel 112x in example methods.

If there is no match—for example, the simple list does not include the patient address from the ADT message—targeted panel filter 115a may discard the received information without any further action or processing resources being consumed by the information in cluster 110. Alternatively, targeted panel filter 115a may label the unmatched information lower-value and set it aside in storage for later processing. Still further, targeted panel filter 115a may hold the unmatched information for enhancement with MPI information, with additional subscriber parameters, and/or with correction methods, and, once the unmatched information is fully enhanced/corrected, again compare the list and information to determine if further action should be taken with the information and/or those actions should target only a subset of panels. With the relative simplicity of a list employed by targeted panel filter 115a at relatively initial stages of healthcare information processing, these features may reduce resource consumption by involving fewer system components and less than all subscriber information, permit more focused information handling, and/or avoid larger or more involved processing or notification work that would be later discarded.

Example embodiment notification cluster 110 may include a comprehensive filter 115b controlled by, or as a component of, logic core 113. Comprehensive filter 115b may filter fully enhanced, corrected, and otherwise present healthcare information in cluster 110. Filter 115b may forward only information matching subscriber parameters to a notification engine 144, and, because healthcare information reaching filter 115b may be fully enhanced, corrected, and otherwise associated through example methods and with other information available in or to cluster 110, comprehensive filter 115b may determine matches based on several different aspects of information and subscriber parameters.

For example, through use of subscriber parameters 120 stored in input structure 112, information gathered from MPI 31, and/or historical analysis created by logic core 113 in example methods, an ADT message 35 in cluster 110 may have typographical information in patient bibliographical information corrected, have patient medical record number from MPI 31 added, and/or have coverage type from a matching subscribing provider's parameters 120 added. Of course any number of other corrections, enhancement, associations, information types, etc. are possible through matching of available data in cluster 110. With all this additional enhancement of the example ADT message, comprehensive filter 115b can match several different types of subscriber parameters 120 with any aspect of the ADT message to determine whether and how the ADT message should be passed to notification engine 114. In this way, several different types of relevant information can be used to exclude or forward healthcare information in cluster 110, ensuring only desired information, based on several potential different parameters, are sent as notifications from cluster 110.

Healthcare notification cluster 110 in example embodiment system 100 may also include a notification engine 114 controlled by logic core 113. As with each component of cluster 114, notification engine may be a functionality wholly programmed in logic core 113 or can be a separate module or even remote serve with its own processor and persistent and transient memory that is programmed or configured hardware to perform notification functionality in accordance with example methods or otherwise.

Notification engine 114 can prepare healthcare notifications from data anywhere in system 100, such as data derived from ADT messages 35, MPI 31, healthcare analysis stored in cluster 110, and/or any other healthcare information. Notification engine 114 may further provide the prepared information in a subscriber notification. Healthcare notifications may be delivered to subscribing providers 160 through a report 127 sent via email, over a direct or secure network, through the Direct standard, in HL7 format, via Internet services, or even hard copy, based on profile information 120 or other rules. Healthcare notifications may be structured as narratives, tables, spreadsheets, existing encounter formats, etc. by notification engine 114. For example, notification engine 114 may compile and email out a report of all healthcare information received, filtered, and/or formatted by logic core 113.

Healthcare notifications may also be prepared and stored with notification engine 114 and provided to subscribing providers 160 only upon their access 128 to healthcare notification cluster 110; a reminder of a new healthcare notification may still be provided in this instance. Still further, a subscribing provider 160 may receive notifications via the Direct standard in real-time from notification engine 114.

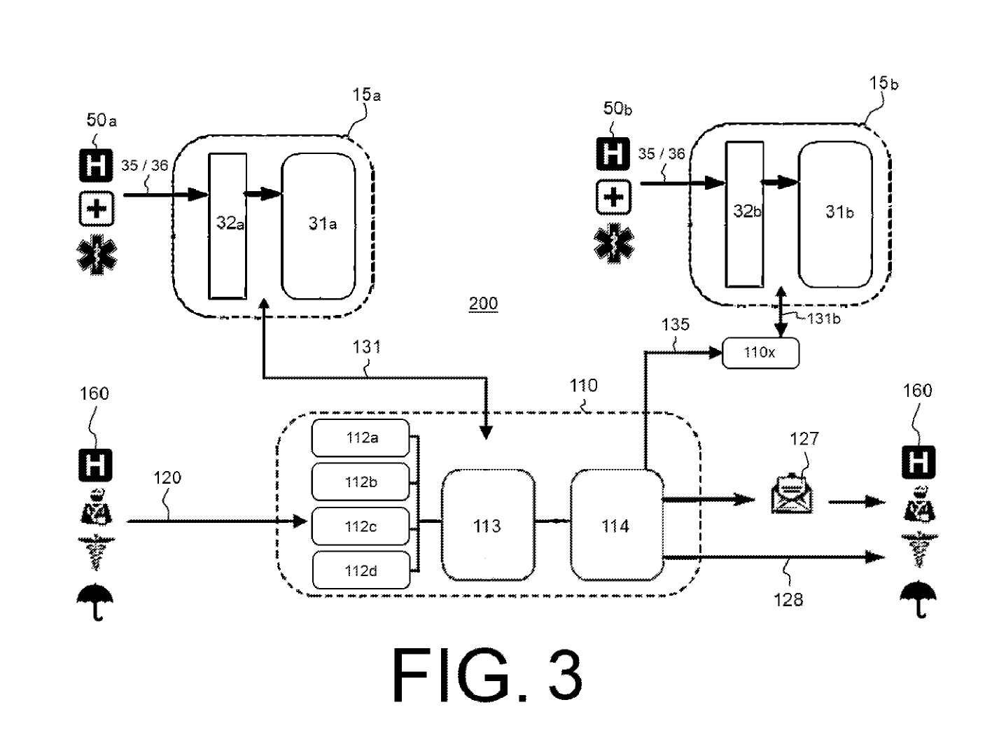

FIG. 3 is an illustration of another example embodiment healthcare notification system 200 useable to deliver desired healthcare to subscribers. Example embodiment system 200 may include several similar elements of example embodiment system 100 described in FIG. 2, redundant details of which are omitted. As shown in FIG. 3, multiple example embodiment healthcare notification clusters 110, 110x may be connected to several health information sources, such as health information exchanges or databases 15a and 15b compiled by separate states or hospital or insurance networks, for example. As such, example embodiment system 200 may be multiple systems 100, with merely an additional notification interface 135 activated between multiple clusters 110, 110x each associated with an exchange 15a, 15b.

As shown in FIG. 3, second exchange 15b may include an intake processor or router 32b to which notification engine 114 may provide healthcare information, including filtered or enhanced ADT messages originally received and processed from exchange 15a, to another cluster 110x associated with a different exchange 15b through notification interface 135. In this way, example embodiment systems may further share healthcare information and well-associated ADT messages through several different exchanges between which patients may move. Any number of example embodiment healthcare notification clusters 110 can operate between any number of healthcare sources, potentially propagating enhanced healthcare notifications or other information across several applicable exchanges. For example, exchanges 15a and 15b could be the same exchange, interfaced both through exchange interface 131 and notification interface 135, or dozens of exchanges like 15a and 15b could each be uniquely networked with example clusters 110x each through one or both of interfaces 131 and 135.

Although networked elements of example embodiment systems 100 and 200 are shown in FIGS. 2 and 3 as individual components with specific groupings and subcomponents, it is understood that these elements may be co-located in a single device having adequately differentiated data storage and/or file systems and processing configurations. Alternatively, the elements shown in FIGS. 2 and 3 may be remote and plural, with functionality shared across several pieces of hardware, each communicatively connected at adequate speeds to provide necessary data transfer and analysis, if, for example, more resources or better logistics are available in distinct locations. Given the variety of example functions described herein, healthcare notification cluster 110 may be structured in a variety of ways to provide desired functionality. Other divisions and/or omissions of structures and functionalities 112, 113, 114, 115a, and 115b among any number of separate modules, processors, servers are useable with example embodiment systems 100 and 200, including execution on a single machine or among distant, exclusive servers and processors.

Similarly, although the example embodiment systems 100 and 200 of FIGS. 2 and 3 are systems that can be configured with and execute example methods, it is understood that example methods are useable with other network configurations, and systems 100 and 200 are useable with other methods of healthcare delivery.

Further, connections shown in example embodiment 100 can be over the Internet, including standard communications protocols such as TCP/IP, or through a programmed application configured to interact with and exchange data in dedicated network or intranet. Servers within example embodiment system 100 may include, for example, conventional domain and/or security and encryption protocols for access and authentication as well as processing capacities to retrieve, deliver, and/or format data for use within example embodiment system 100. Or, for example, all of example embodiment system 100 may be configured in a single machine, with an internal bus providing communication between various elements. Further, healthcare notification cluster 110 may also include its own data storage capabilities to handle and persist user inquiries and/or create a processed database mirroring in part data from separate MPI 31.

### Example Method 1

Based on healthcare information received from a healthcare information source and subscriber information, healthcare notification cluster 110 can collect, compile, enhance, analyze, and/or provide specific and well-tailored healthcare information for subscribing providers 160. As shown in FIG. 2, healthcare notification cluster 110 includes a logic core 113 interfaced with and/or controlling operation of HIE 15, input structure 112 including individual panels 112a-d, targeted panel filter 115a, comprehensive filter 115b, and/or notification engine 114. Logic core 113 may coordinate actions of example methods, including healthcare message processing and analysis, retrieval of healthcare information, delivering healthcare information in accordance with subscriber parameters, enhancement of MPI 31, and/or several other functions discussed further herein.

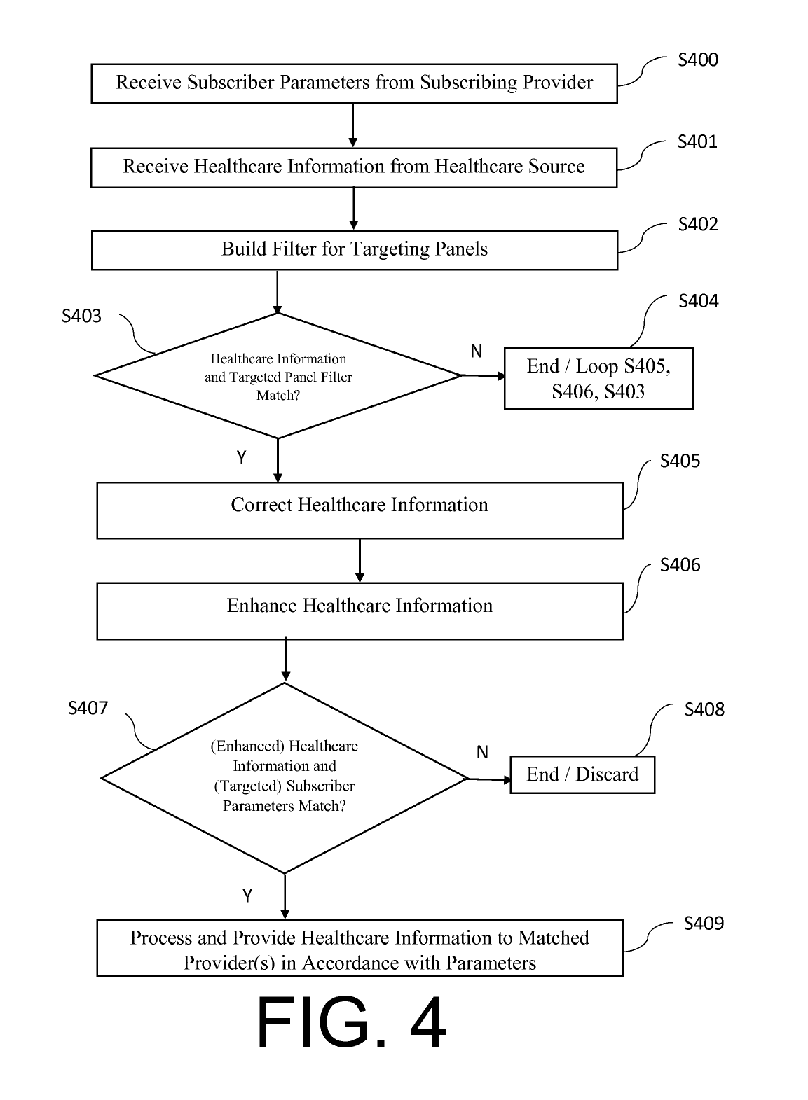

FIG. 4 is a flow chart illustrating an example method of healthcare information and notification processing. Using an example network 100 from FIG. 2, logic core 113 may provide healthcare message processing in the example method of FIG. 4. In S400, subscriber parameters 120 are received from one or more subscribing providers 160. S400 may be executed before, after, and/or in real time with other actions in example methods, such that subscriber parameters 120 may be updated whenever, automatically or at a discretion of a subscriber 160 or other ruleset or actor. In S400, receiving subscriber parameters 120 may further include processing and/or storing such parameters by an input structure 112, such as in input structure/panel 112b associated with the subscriber 160.

In S401, healthcare information is received from a source. For example, incoming notifications/information to HIE 15 may be monitored and/or received by healthcare notification cluster 110 through interface connection 131. Incoming messages may include standard or enhanced ADT messages 35 or other information from clinical feeds 36, for example. In S401, several messages from several different sources may be received, and receiving S401 may include processing and/or storing received healthcare information, for example, to extract relevant patient data and/or decrypt or arrange data therein based on message type and source configuration.

In S402, a simplified list of subscribers and notification criteria can be constructed from subscriber parameters and/or other information. For example, targeted panel filter 115a may build a filter for targeting panels of subscribed patients versus provider 160 by extracting patient names or other identifying information from parameters 120 as they are received in S400 and matching them with the provider having the roster with the patient information. Or, for example, targeted panel filter 115a may create a list correlating actions for notification—like a discharge action—received from parameters 160 with the provider requesting notification upon such action. Targeted panel filter 115a may also store and update the filter in S402 at given times and/or continuously. Although this is the default for all actions, S400, S401, and S402 may occur in any order, given proper persistence of subscriber information, targeted panel data, and healthcare information in a network executing an example method.

In S403, received healthcare information in S401 and targeted panel filter built in S402 are compared to determine further treatment of the information. For example, in S403, logic core 113 may instruct targeted panel filter 115a to compare a patient identifier, such as a name, address, patient ID, birthdate, SSN, etc. and/or portions thereof, in an unenhanced received ADT message 35 against a filter correlating the identifier with one of the subscriber-specific panels 112x. Logic core 113 may make a coarse determination of which messages are responsive to a specific provider 160 and associated panel 112x based on the comparison in S403.

If a positive determination is made in S403, filter 115a and/or logic core 113 may continue with operations, including the remainder of FIG. 4 from S405 onward, example methods disclosed in the incorporated documents, and/or other operations. These further operations may be conditioned based on the positive identification in S403. For example, correction or enhancement of received healthcare information may be conducted only with respect to the identified, matching subscriber panel in S403. If a negative determination is made in S403, the compared healthcare information may be discarded without further action. Alternatively, the non-matching healthcare information can be held for enhancement and/or correction in other example methods and re-compared in S403 post-enhancement. If no match persists, the information may be discarded. Still alternatively, the unmatched information may be used in other operations and example methods without being discarded.

In S405 and S406, the received healthcare information from S401 can be corrected and/or enhanced, potentially based on the comparison in S403. For example, logic core 113 may further process received ADT messages 35 provided from HIE 15 to discard those messages or portions of messages containing duplicate, incorrect, or low-value contents. For example, a provider 50 may generate an ADT message 35 for an internal transfer that has no meaning outside the provider facilities, or a received healthcare information may include typographical errors in a patient's information or an impossible/redundant administrative status change, such as duplicative admittances for the same patient and facility. Logic core 113 may analyze received healthcare information for such errors, for example, under internal rules for eliminating impossible types of actions, clear typographical errors, or unusable data in S405.

In S406, additional information and associations can be added to the healthcare information, based on other information in or available to the enhancer. For example, HIE 15 may autonomously or under the direction or query of logic core 113 associate ADT message 35 or other clinical feed data with other patient information, like record numbers, biographical information, health history information, citizenship records, consent information, etc. Such enhancement in S406 may occur concurrently with any initial matching and/or correction in S403 and S405.

Additionally or alternatively, logic core 113 may analyze received healthcare information for errors and/or incompleteness in S405 and S406 by comparing information content against known correct client information, such as the higher-reliability information in subscriber parameters 120. Subscribing providers 160 may be under less duress and/or exercise greater business care in fully and/or properly identifying patients and related healthcare information in their parameters 120. In S405 and S406, only subscriber parameters 120 from a particular panel 112x or otherwise associated with a matched provider from S403 may be used. This targeted correction may reduce resource consumption and/or allow more comprehensive correction or enhancement from a subset of subscriber panels 112. Yet further, parameters 120 may be curated and re-checked over a history of received messages and other healthcare information, offering a more accurate source of contextual information and data associations therein. Incorrect or useless messages or portions of the information identified in S405 under any approach may be corrected or disposed of without further storage, processing, and/or passing them on to subscribing providers 160. Similarly, incomplete or brief information may be completed or enhanced for more useful analysis and consumption under any approach in S405.

In S407, the healthcare information received in S401, potentially corrected and/or enhanced from other information sources in S405 and S406, can be compared against subscriber parameters for matching information and notification conditions. For example, comprehensive filter 115b may analyze all aspects of the ADT message enhanced with exchange data against all parameters 120 stored in input structure 112 to fully determine whether any aspect of the enhanced data matches parameters for notification. Comprehensive filter 115b may alternatively compare the enhanced information against only parameters 120 stored in a specific panel 112x identified in S403. Because comprehensive filter 115b may act on healthcare information immediately before its being provided and/or after full enhancement and correction, comprehensive filter 115b may be configured to compare and match several different aspects of enhanced healthcare information, including information potentially picked up from an outside exchange or subscriber parameter, like self-pay status, patient participation in state healthcare programs, patient confidentiality and consent flags for different types of information, etc. Thus, all associated information for any received healthcare information can be analyzed for a match in S407.

If S407 determines that the healthcare information matches a subscriber parameter, the information may be prepared in a notification to the matched subscriber from S407. If there is not a match in S407, the received information may be filtered out, by being discarded or otherwise held without being forwarded to a subscriber.

For example, in S407, logic core 113 may determine that a received ADT message 35 for a discharge from a specialist facility does not match any subscriber parameter 160, because, for example, the patient in the ADT message is not identified in any rosters stored in input structures 112, and/or because the specialist-discharge event is not matched or is specifically excluded from parameters 120 in input structures 112. In this instance, logic core 113 may not forward the information on to notification engine 114, and no provider may be bothered with the non-matching information. Or for example, logic core 113 may determine that the ADT message 35 matches in relevant part with subscriber parameters 120 for multiple subscribing providers 160. In this instance, logic core 113 may forward the information on to notification engine 114 and/or further process the information to be provided to the multiple matched providers.

In S409, the matching healthcare information may be further processed based on subscriber requirements and provided to the matched subscriber. For example, logic core 113 may process matched healthcare information against subscriber parameters 120 in order to determine what portion of the information should be sent, what formatting should be applied, when the information should be provided, etc. Logic core 113 may format and time any notifications generated based on a positive match on parameters 120. This further processing may be executed against only subscriber parameters in matching panels 112x determined in S403, if a targeted panel filter 115a was used.

For example, subscribing providers 160 may provide notification limitations within parameters 120, such as a special formatting for particular types of encounters and/or patients. Logic core 113 may further compare such notification limitations against each ADT message 35 to format noncompliant information and forwarded those complying with subscriber's notification limitations to notification engine 114 to make available to the subscriber in accordance with any other client parameters such as delivery format or frequency.

As a further example of S409, logic core 113 may control notification engine 114 to generate healthcare notifications only at appropriate instances based upon subscriber parameters 120. For example, whenever logic core 113 monitors an ADT message 35 generated based on a client encounter for a client included in a roster in subscriber parameters 120, a healthcare notification may be generated for the subscribing provider 160. Alternatively, if subscriber parameters 120 requested notifications only at weekly intervals, a notification of the encounter observed in the ADT message 35 may be held until the requested interval has passed.

In S409, the received, and potentially corrected and enhanced, healthcare information is provided as a notification only to matching subscribing providers, potentially following processing and formatting. Healthcare notifications generated in S409 may include a wide variety of detail based on subscriber parameters and available healthcare information. For example, healthcare notifications may include only the ADT message content that triggered the notification, or healthcare notifications may include any or all healthcare information identified in MPI 31 for a patient whenever a responsive notification is generated for that patient. Subscriber parameters 120 may indicate a level and type of information requested in healthcare notifications; for example, a subscribing provider 160 may list internal identifiers, name of a primary care provider, record number, and/or any other contextual information to aid their bookkeeping that can be added into notifications by engine 114.

As another example of S409, logic core 113 may select particularly high-value or relevant healthcare data for inclusion in a notification. For example, an insurance provider can submit subscriber parameters 120 requesting notifications for treatment or prescription changes, and example embodiment system 100 may provide a notification to the provider each time an ADT message 35 contains an encounter with a changed treatment or prescription; the notification may also contain information about a new condition or hospital encounter that resulted in change if this information is determined as relevant or important, for, say, determining whether the new prescription is effective or wasteful, by the logic core 113.

Notification engine 114 can prepare healthcare notifications including data present solely in healthcare notification cluster 110, such as data stored in a local database that was filtered from ADT messages 35 and MPI 31 by logic core 113, or with information accessible anywhere in example embodiment system 100. For example, cluster 110 may have previously identified several different data entries relating to a particular patient in MPI 31. Notification engine 114 may pull and combine all requested information among the previously-identified information in MPI 31 for presentation in a subscriber notification in S409.

Healthcare notifications may be delivered to subscribing providers 160 through a report 127 sent via email, over a direct or secure network, through the Direct standard, in HL7 format, via Internet services, or even hard copy, based on profile information. Healthcare notifications may be structured as narratives, tables, spreadsheets, existing encounter formats, etc. For example, a subscribing provider 160 may have requested a daily notification in HL7 format for a list of active patients in parameters 120, and notification engine 114 may compile and email out a report of all encounters in HL7 format for the identified patients within a daily interval.

Alternatively, in S409, healthcare notifications may be prepared and stored with notification engine 114 and provided to subscribing providers 160 only upon their access 128 to healthcare notification cluster 110; a reminder of a new healthcare notification may still be provided in this instance. Still further, a subscribing provider 160 may receive notifications via the Direct standard in real-time, permitting providers to readily follow-up with patients at each encounter, such as admission or discharge.

It is understood that several aspects of the methods possible from the flowchart of FIG. 4 are optional and may occur only in specific conditions. For example, only S400, S401, S407, and S408 may occur in the event of basic healthcare information filtering, such as when encounters from a source are received that do not match with any subscribing provider's parameters without the use of any targeted panel filter. Or, for example, S400, S401, S402, S403, S405, S406, S407, and S409 may all occur when healthcare information is received that is responsive to a subscriber's parameters, is eligible for correction and enhancement based on additional information in a particular subscriber's panel, and is formatted and provided as defined by those subset of subscriber parameters. Several other action permutations are of course possible. As such, subscribing providers 160 may receive responsive, well-tailored healthcare notifications only in accordance with their parameters through example methods, while avoiding the universe of healthcare information that is not responsive to provider needs.

Some example methods being described, it is understood that one or more example methods may be used in combination and/or repetitively to produce multiple options and functionalities for subscribers. Example methods may be performed by properly programming or hardware configuring notification networks to receive healthcare information and subscriber information and act in accordance with example methods. Similarly, example methods may be embodied on non-transitory computer-readable media that directly instruct computer processors to execute example methods and/or, through installation in persistent memory, configure general-purpose computers connected to subscribers and healthcare information sources into specific healthcare notification networks that execute example methods.

Example methods and embodiments thus being described, it will be appreciated by one skilled in the art that example embodiments may be varied through routine experimentation and without further inventive activity. For example, subscribers are described as providing subscriber parameters to define the parameters of their information delivery service, it is understood that subscriber parameters may be automatically received in example embodiment networks for any subscriber through default options, a controlling ruleset, or through other controlling subscribers. Variations are not to be regarded as departure from the spirit and scope of the exemplary embodiments, and all such modifications as would be obvious to one skilled in the art are intended to be included within the scope of the following claims.

What is claimed is:

1. A method of managing healthcare information with a computer processor-based healthcare notification delivery network, the method comprising:
receiving, at the healthcare notification delivery network, subscriber parameters for a subscriber;
receiving, with the healthcare notification delivery network, healthcare information from a healthcare information source;
comparing, with the healthcare notification delivery network, at least one of,
the healthcare information with a simplified list of the subscriber versus at least one notification identifier, wherein the simplified list is derived from the subscriber parameters, and
enhanced healthcare information with the subscriber parameters, wherein the enhanced healthcare information is the healthcare information with additional related information from at least one of the healthcare information source and the subscriber parameters; and
providing, with the healthcare notification delivery network, a healthcare notification to the subscriber, wherein the healthcare notification includes at least a portion of the healthcare information, and wherein the providing is executed only if the comparing determines a match between at least one of the healthcare information versus the simplified list and the enhanced healthcare information and the subscriber parameters.

2. The method of claim 1, wherein the receiving subscriber parameters occurs before and independent of the receiving healthcare information, wherein the subscriber parameters are received directly from the subscriber, and wherein the providing is performed based on at least one of timing, formatting, delivery address, and delivery method requirements identified in the subscriber parameters.

3. The method of claim 1, wherein the receiving subscriber parameters is performed multiple times with distinct providers such that the healthcare notification delivery network includes a plurality of subscriber parameters each for one of a plurality of subscribers.

4. The method of claim 3, wherein the comparing includes comparing the healthcare information with the simplified list, and wherein the simplified list includes the plurality of subscribers each versus at least one notification identifier derived from the subscriber parameters of the associated provider.

5. The method of claim 4, wherein the providing provides the healthcare notification to only each subscriber of the plurality of subscribers for whom the comparing determines a match, and wherein the providing is performed based on at requirements identified in the subscriber parameters for the matched subscriber.

6. The method of claim 4, further comprising:
enhancing, with the healthcare notification delivery network, the healthcare information with related information from the subscribing parameters, wherein the enhancing is performed only if the comparing determines a match, and wherein the subscribing parameters used in the enhancing are only the subscribing parameters provided by the matched subscriber.

7. The method of claim 4, wherein the healthcare information is held or discarded without being provided if the comparing determines no match.

8. The method of claim 1, wherein the comparing includes comparing the enhanced healthcare information with the subscriber parameters, the method further comprising:
enhancing, with the healthcare notification delivery network, the healthcare information with additional related information from at least one of the subscribing parameters and the healthcare information source so as to create the enhanced healthcare information before the comparing.

9. The method of claim 8, further comprising:
correcting, with the healthcare notification delivery network, the healthcare information before the comparing, wherein the correcting is based on at least one of the subscriber parameters, the healthcare information source, and error correction rulesets in the healthcare notification delivery network.

10. The method of claim 8, wherein the healthcare information is an ADT message received from a health information exchange describing a patient encounter with a healthcare provider, and wherein the enhancing adds at least one of patient biographical information, medical history, and insurance information from the subscribing parameters or the health information exchange to the ADT message.

11. The method of claim 8, further comprising:
discarding the healthcare information if the comparing determines no match.

12. The method of claim 1, wherein, the comparing compares both the enhanced healthcare information with the subscriber parameters and the healthcare information with the simplified list.

13. The method of claim 12, wherein the receiving subscriber parameters is performed multiple times with distinct providers such that the healthcare notification delivery network includes a plurality of subscriber parameters each for one of a plurality of subscribers, the method further comprising:
enhancing, with the healthcare notification delivery network, the healthcare information with additional related information from at least one of the subscribing parameters and the healthcare information source so as to create the enhanced healthcare information.

14. The method of claim 13, wherein the enhancing is performed only if the comparing determines a match between the healthcare information with the simplified list and is performed before the comparing compares the enhanced healthcare information with the subscriber parameters, and wherein the subscriber parameters are only parameters received from the matched provider of the plurality of providers from the list.

15. The method of claim 1, wherein,
the subscriber is operated and controlled by a separate operator and controller from the healthcare notification delivery network,
the healthcare information source is a health information exchange operated and controlled by a separate operator and controller from the healthcare notification delivery network,
the healthcare information includes at least a portion of a patient's, name, address, city, state, zip code, social security number, date of birth, phone number, or gender,
the healthcare information is a record, created by the healthcare source and received by the healthcare notification delivery network, and wherein the record is created and received only when the healthcare source completes an action in response to a request for medical treatment,
the healthcare notification includes information contained in the record, and
the subscriber is at least one of an insurance provider, a healthcare provider, and a government entity.

16. A healthcare notification delivery network comprising:
a persistent memory configured to store subscriber parameters; and
a computer processor connected to a healthcare information source and a providing subscriber, wherein the processor is configured to,
receive healthcare information from the healthcare information source,
receive the subscriber parameters from the providing subscriber,
compare at least one of,
the healthcare information with a simplified list of the subscriber versus at least one notification identifier, wherein the simplified list is derived from the subscriber parameters, and
enhanced healthcare information with the subscriber parameters, wherein the enhanced healthcare information is the healthcare information with additional related information from at least one of the healthcare information source and the subscriber parameters, and
provide a healthcare notification to the subscriber, wherein the healthcare notification includes at least a portion of the healthcare information, and wherein the providing is executed only if the comparing determines a match between at least one of the healthcare information versus the simplified list and the enhanced healthcare information and the subscriber parameters.

17. The network of claim 16, wherein the processor is further configured to receive subscriber parameters from a plurality of subscribers, the network further comprising:
a plurality of the persistent memories each configured to store parameters for only a single subscriber.

18. The network of claim 17, wherein the processor is further configured to create the simplified list, wherein the simplified list further includes the plurality of subscribers each versus at least one notification identifier from the subscriber parameters for the associated subscriber, and wherein the persistent memory is configured to store the simplified list.

19. The network of claim 17, wherein the processor is configured to compare both the enhanced healthcare information with the subscriber parameters and the healthcare information with the simplified list

20. A non-transitory computer readable medium, wherein the medium includes data structures that instruct a computer processor to,
receive subscriber parameters for a subscriber;
receive healthcare information from a healthcare information source;
compare at least one of,
the healthcare information with a simplified list of the subscriber versus at least one notification identifier, wherein the simplified list is derived from the subscriber parameters, and
enhanced healthcare information with the subscriber parameters, wherein the enhanced healthcare information is the healthcare information with additional related information from at least one of the healthcare information source and the subscriber parameters; and
provide a healthcare notification to the subscriber, wherein the healthcare notification includes at least a portion of the healthcare information, and wherein the providing is executed only if the comparing determines that the healthcare information matches the subscription parameters.
